(19) United States
(12) Patent Application Publication
(10) Pub. No.: US 2003/0075930 A1
(43) Pub. Date: Apr. 24, 2003

(54) Adjustable latch slidable mechanism for tubular door locks

(76) Inventor: Wen Mak, Zhongshan City (CN)

Correspondence Address: William G. Lane, William G. Lane, Inc., P.C., Suite 250, 16485 Laguna Canyon Road, Irvine, CA, 92618, US

(21) Appl. No.: 10/226,649

(22) Filed: Aug. 23, 2002

Related U.S. Application Data
(60) Provisional application No. 60/314,690, filed on Aug. 24, 2001.

(51) Int. Cl. E05C 1/00

(52) U.S. Cl. 292/1.5

(57) ABSTRACT

A latch for a tubular door lock employing a cam rotatable by door knob or door lever to retract a bolt extracting plate backward to open the lock which is positioned between two parallel framing plates and adapted to move from anterior position to posterior position with respect to the plates and an exterior box frame enclosing the parallel plates and the cam and supporting the cam for rotation. The external box frame adapted to be moved anteriorly or posteriorly to enable the tubular door lock to be utilized in a 2⅜ or 2¾ setback position. The longitudinal move of the external box frame being limited by teeth extending out from one plate and riding in grooves in one side of the external box frame and registration of the cam for a 2⅜ inch setback or 2¾ inch setback being fixed by at least one protrusion extending inwardly from the box frame and engaging corresponding holes in one of the plate frames, the anterior hole in registration with a 2⅜ inch setback and the posterior hole in registration with a 2¾ inch setback for the tubular door lock.

Applicant claims the benefit of prior filed co-pending Provisional Application Serial No. 60/314,690 for Adjustable Latch Slidable Mechanism for Tubular Door Locks, filed on Aug. 24, 2001.

### FIELD OF THE INVENTION

The present invention is directed to a new and improved duplex adjustable latch for tubular door locks. The duplex adjustable latch can be utilized in doors having a 70 millimeter (2¾ inch) or a 60 millimeter (2⅜ inch) setback.

### BACKGROUND OF THE INVENTION

Most residential doors, office doors, and hotel and motel doors, except for high security doors, have setbacks for the door locks of either 70 millimeter (2¾ inch) or 60 millimeter (2⅜ inch) setbacks. The setback is the distance from the leading edge of the door to the axis of the door knob or door lever. Up until the mid-1980's, latch assembly in combination with the door bolt assembly, often called lockset, tubular door lock, tubular lock, door lock, door lock assemblies, and the like, were made either for 70 millimeter or 60 millimeter setbacks. Thus, locksmiths, hardware stores, and building supply outlets had to carry door lock assemblies for 70 millimeter setbacks and for 60 millimeter setbacks. In addition, door lock manufacturers had to manufacture door assemblies in two sizes, one for the 70 millimeter setback and one for the 60 millimeter setback. Door lock assemblies normally comprise two parts: the door bolt and its retraction housing and latch or actuator assembly, which when actuated by the door knob or door lever, retracts the bolt into the bolt retraction housing to allow the door to be opened.

Most doors are drilled out with templates to provide for the integral edge hole to receive the bolt retraction housing in conjunction with the latch or actuator assembly, and the door knob or door lever cavity which intersects the door bolt housing and cavity at right angles to receive the door knob assembly or the door lever assembly (see Figures in U.S. Pat. Nos. 4,470,278; 5,551,736; 5,335,950; 5,257,837; and 5,169,184, the disclosures of which are incorporated herein by reference). Templates assure that the cavities are aligned properly with each other and have the proper setback. Accordingly, the door lock assembly must meet dimensional tolerances such that the door lock assembly can be inserted into the door lock assembly cavity and be properly aligned to receive the door knob assembly or the door lever assembly through the door knob assembly or door lever assembly cavity. Most doors are drilled for 2⅜ or 2¾ inch setbacks and dual backset door lock assemblies are preferred. Preferably the door lock assemblies have adjustable latch slidable mechanism to convert the door lock assembly from 2¾ inch (70 millimeter) setback to 2⅜ inch (60 millimeter) setback and vice versa. Such door lock assemblies must maintain the dimensional tolerances of the door lock assembly either in the 70 millimeter setback position or in the 60 millimeter setback position. In addition, door lock assemblies must be securely constructed and yet be designed so that they can be made and assembled with a minimum of machining steps and manual steps. The adjustable latch slidable mechanism for tubular door locks of the present invention meets these conditions.

### SUMMARY OF THE INVENTION

The dual backset adjustable latch for tubular door lock of the present invention comprises a latch-bolt assembly and a connected actuator assembly.

The latch-bolt assembly having a bolt case with an anterior face plate and posterior wall, the posterior wall having a hole, a bolt extendible out of the anterior face plate and retractable into the bolt case, retracting means within the case connected to the bolt, and a bolt extracting plate having an anterior portion and a posterior portion with two longitudinal spaced apart tines, a set of protuberances extending laterally from each tine, the bolt extracting plate extending through the hole in the posterior wall with the anterior portion of the bolt extracting plate within the case and connected to the retracting means and the posterior portion extending out from the posterior wall, the bolt being retracted into the bolt case when the posterior portion of the bolt extracting plate is moved posteriorly away the bolt case and extended out from the case when the posterior portion is moved anteriorly towards the bolt case.

The actuator assembly has an anterior end and posterior end with the anterior end secured to the posterior wall of the bolt case, top and bottom frame plates having anterior ends and posterior ends, a cam, a box cover, and optionally a washer. The frame plates has means for securing their anterior ends to the posterior wall of the bolt case. The frame plates has axially aligned notches and holes to receive mounting posts of a door lock rose, and axially aligned elongated holes having longitudinal axes. Optionally and preferably the elongated hole of one frame plate is gourd shape with the center portion of the elongated hole between its ends constricted. Optionally, but preferable, one of the frame plates has at least one finger near its posterior end extending to the other frame plate, the other frame plate having at least one finger slot near its posterior end. Each finger extending to and through a separate finger slot in the other frame plate. Optionally, but preferably, at least one of the frame plates has at least two registration holes which are longitudinally spaced apart.

The cam has a cylindrical body with first and second portions adapted to be received in the elongated holes of the frame plates and to rotate therein and two teeth with cam surfaces adapted to engage the protuberances on the tines of the bolt extracting plate. The cylindrical body has a hole coaxial with its axis of rotation adapted to received a door lock spindle for rotation of the cam. The cam is positioned between the frame plates and adapted to be moved longitudinally within the elongated holes. When one of the frame plates has an elongated hole which has a constricted center portion between its ends, the first portion of the cylindrical body has two parallel flats aligned with the cam teeth. The distance between the flats is less than the diameter of the first portion which permits passage of the first portion through the constricted center portion of the elongated hole. The cam can be moved longitudinally along elongated hole with the constricted center portion when the two parallel flats of the first portion of the cylindrical body are parallel to the longitudinal axis of the elongated hole which aligns the cam with its teeth pointing forward.

A washer is preferred, but optional. Preferably the washer biases the cam along its axis of rotation. The washer can be an arch-shaped or wave-shaped. The washer can have an oblong hole adapted to be received by the first portion of the cylindrical body when the first portion has the two parallel flats and is adapted to rotate with the cam. Optionally the hole of the washer could be cylindrical. The oblong hole of the washer has the cross section of the first portion of the cylindrical body that has two parallel flats. The washer is mounted on the first portion between the cam teeth and one of the frame plates.

The posterior portion of the bolt extraction plate is positioned between one of the frame plates and the cam with one of the two portions of the cylindrical body positioned between the two tines, the protuberances on the tines extending away from the tines towards the other frame plate, each protuberance adapted to be engaged by a cam teeth.

The box cover has an anterior end and posterior end, parallel side walls, parallel top and bottom walls, and an open anterior end. The top and bottom walls having a posterior and anterior notches to receive mounting posts of a door lock rose; the notches being axially aligned when the box cover is positioned at the either backset position with the notches and holes of the frame plates. The top and bottom walls having axially aligned bushings to receive for rotation the first and second portions of the cylindrical body of the cam. The frame plates are positioned within the box cover with the exterior sides of the top and bottom frame plates adjacent the inner sides of the top and bottom walls of the box cover respectively. The box cover is adapted to longitudinally slide over the frame plates. At least one of the top or bottom walls has at least one elongated slot near its posterior end when one of the frame plates has at least one finger. Each finger extending through a separate elongated slot and adapted to move along the length thereof when box cover is slide from one backset position to the other backset position. At least one finger engaging one end of an elongated slot when the cover is slid to one backset position and at least one finger engaging the other end of an elongated slot when the box cover is slid to the other backset position. The wall of the box frame adjacent the frame plate having the optional two registration holes has at least one protuberance extending toward the frame plate and positioned to engage one registration hole when the box cover is slid to one back set position and to engage the other registration hole when the box cover is slid to the other back set position.

The improved adjustable latch slidable mechanism comprises a latch-bolt head assembly and actuator assembly. The latch-bolt head assembly having a case and connected to a latch-bolt extracting plate with a pair of extensions. The extensions have two pairs of perpendicular lateral protrusion. The latch-bolt head can be moved frontward (bolt extension for locking) or rearward (bolt retraction for unlocking) in the housing by pushing or pulling the bolt extracting plate. There are two types of latch-bolt head assemblies. The first is 90° opening angle assembly usually used with knob. The second is 45° opening angle assembly usually used with lever. (Unless otherwise specified the latch-bolt head assembly hereinafter means both the 90° and 45° opening angle latch-bolt head assemblies or mechanisms). Although they are referred to as a 90° opening angle assembly or a 45° opening angle assembly, the actual degree of rotation can vary anywhere from 45° to over 100° for a 90° open angle assembly and from 30 to 60° for a 45° open angle assembly. The present actuator can be used with conventional well-known latch-bolt head assemblies such as those described herein and described in the prior art, for example see U.S. Pat. Nos. 5,335,950; 5,257,837; 4,746,154; 4,711,477; 4,687,239; 3,441,269 and the like.

The actuator assembly is secured to the latch-bolt head assembly and operates the latch-bolt assembly.

In one embodiment, the actuator comprises a top plate with a gourd-shape hole and a bottom plate with an oblong hole are fixed to the end of the latch-bolt case. A cam, conveniently a cast cam, such as a steel, bronze, zinc-die cast cam, is placed between said plates and moved between end portions of the said plates when sliding an outside latch or box cover. The cam has a pair of teeth to engage the protrusions of the extensions when it is rotating. An arch-shaped or wave-shaped washer is mounted on the cam body for rotation with the cam. An outside latch or box cover surrounds the top plate and bottom plate. The outside latch cover has two bushings. The cam body is mounted in the two bushings for rotation and to keep the cam in the proper position when the cover is moved or slid longitudinally backward or forward to adjust the backset.

The outside latch cover or box cover can include a pair of half-ball protuberances extending inwardly and adapted to engage a pair of holes arrayed in two groups in the top plate to keep the latch cover in the forward or rearward backset position.

Preferably the cam body has a cross section in the portion that engages the washer that has the same shape as the washer hole. This prevents the washer from rotating independently of the cam. With the help of the washer, the vertical or axial movement of the cam between the top and bottom plates is limited. The arc shape of the washer can bias the cam against the bottom plate.

An objective of the invention is to provide an easy way to select the right backset position of the door lock or latch for either the 60 mm (2⅜″) or the 70 mm (2¾″) backset configuration.

It is another object of the invention to keep the cam teeth in right position via the gourd hole of the top plate when the cam is moved via the outside latch or box cover from one end to the other end of the gourd-shaped hole of the top plate and oblong hole of the bottom plate to obtain the right backset. By keeping the cam teeth straight ahead when setting the backset, the teeth do not get hung up on the protuberances.

This adjustable latch slidable mechanism or tubular door lock is a combination of a latch-bolt head assembly and a latch-bolt transfer device, also called the actuator or actuator assembly, that is connected to the latch-bolt head assembly. The latch-bolt transfer device or actuator assembly is comprised of the top plate, the bottom plate, the latch-bolt extracting plate, the cam, the cam washer and the outside latch cover.

This adjustable latch slidable mechanism or tubular door lock can be switched to a 60 mm (2⅜″) or the 70 mm (2¾″) backset by sliding the outside latch cover toward or away from the case, i.e. between two positions. The adjustable latch slidable mechanism or tubular door lock is used with knob or handle locksets having a spindle, such as a square transfer member, which is driven by the door knobs or handles to drive, i.e. rotate, the cam which drives, i.e. moves, the bolt extracting plate.

More details of the invention will be described hereinbelow with reference to annexed drawings.

### BRIEF DESCRIPTION OF THE DRAWINGS

FIG. 1 is an exploded view of an adjustable latch slidable mechanism for a tubular door lock in accordance with this invention. It is assembled with a 90° opening angle latch-bolt head assembly.

FIG. 2 is an exploded view of the 450 opening angle adjustable latch slidable mechanism for a tubular door lock in accordance with this invention;

FIG. 3 is an enlarged view of the cam and arch washer of FIGS. 1 and 2;

FIG. 4 is a plan view of the adjustable latch slidable mechanism in the 60 mm (2⅜″) backset position;

FIG. 5 is a partial cross sectional view taken along lines A-A of FIG. 4;

FIG. 6 is a plan view of the adjustable latch slidable mechanism in the 70 mm (2¾″) backset position;

FIG. 7 is a partial cross sectional view taken along A′-A′ of FIG. 6;

FIG. 8A illustrates the adjustable latch slidable mechanism of the present invention in the 60 millimeter backset position;

FIG. 8B shows the adjustable latch slidable mechanism of the present invention in the 70 millimeter backset position;

FIG. 9 is a cross sectional view of the 90° opening angle adjustable latch slidable mechanism in the unlocked position;

FIG. 10 is a cross sectional view of the 90° opening angle latch-bolt head assembly in the locked position;

FIG. 11 is a cross sectional view of the 45° opening angle adjustable latch slidable mechanism in the unlocked position; and

FIG. 12 is a cross sectional view of the 45° opening angle latch-bolt head assembly in the locked position.

### DETAILED DESCRIPTION OF THE INVENTION

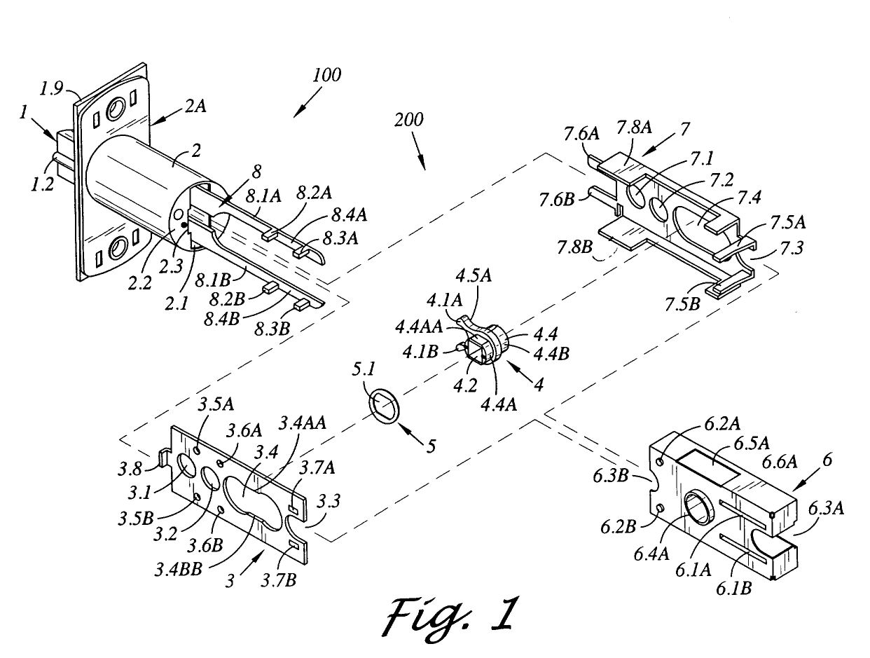

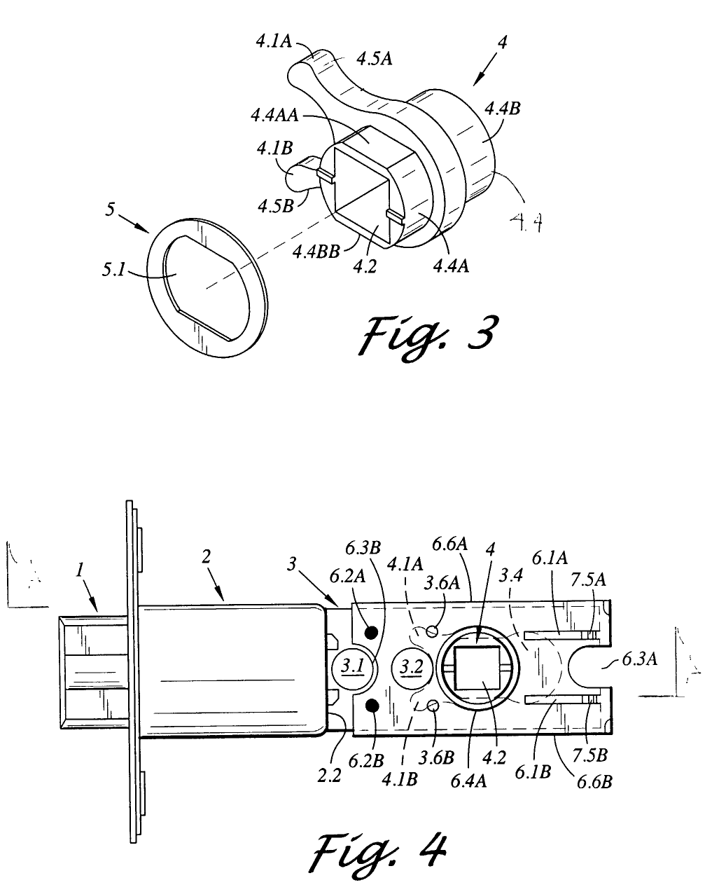

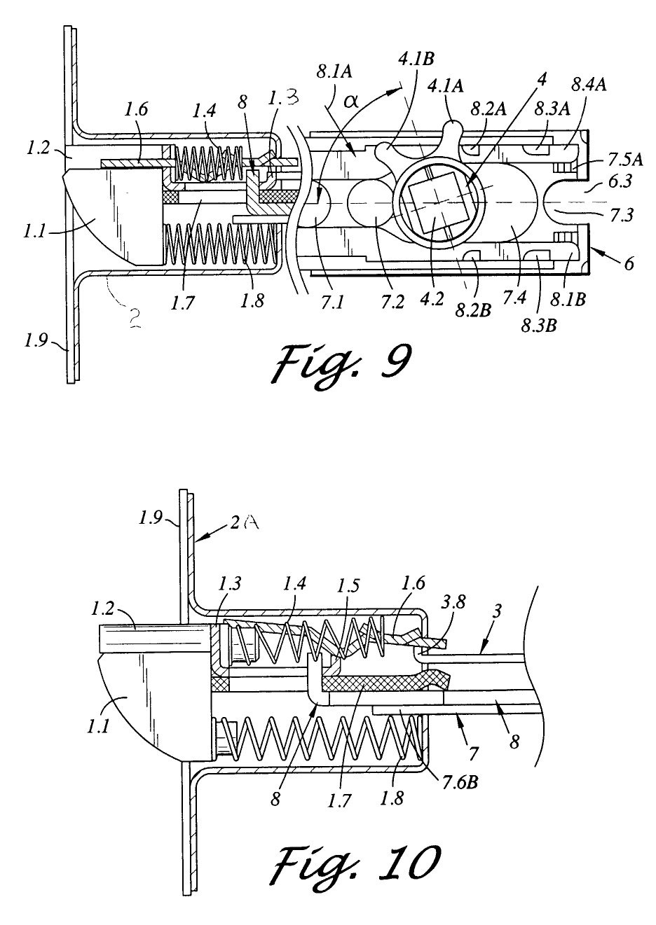

Referring to FIGS. 1 and 3, a deadbolt assembly, also called a tubular door lock, tubular lock, adjustable latch slidable mechanism, dual backset latch assembly, dual backset deadbolt assembly, a duplex latch-bolt mechanism, and the like, is shown including the deadbolt assembly 100 and the actuator assembly 200. Although the invention is described with a deadbolt assembly, which is the type of assembly normally used on exterior doors to retard entry by burglary, regular bolt or latch-bolt assemblies, such as shown in U.S. Pat. Nos. 4,927,199; 4,615,549; and 4,850,626, can also be utilized in the present invention which are used for interior doors which are normally not made for anti-burglary. The deadbolt assembly comprises the deadbolt assembly 1 comprising the bolt 1.1 or deadbolt, or latch-bolt head, or bolt head, or latch-bolt, the trigger bolt 1.2, or dead latch-bolt or anti-burglary bolt, or safety bolt, and the bolt retraction assembly contained within the latch-bolt case 2, also called deadbolt housing, cylinder, housing, latch housing, lock cylinder, casing cylinder, casing, mainframe, door-mounted casing, and the like. Deadbolt assemblies are illustrated in FIGS. 9-12, and described in U.S. Pat. Nos. 4,687,239; 4,711,477; 4,746,154; 5,169,184; and 5,335,950 which description is incorporated by reference herein. The deadbolt assembly 100 also includes bolt extracting plate 8, also called extensions, pulling plate, actuating plate, and the like. The latch-bolt case 2 includes face plate 2A secured to a fixing plate or front facing plate 1.9. The bolt extracting plate 8 extends out of opening 2.1 from the rear or posterior wall 2.2 of the latch-bolt case 2. The side of opening 2.1 has a notch 2.3 to receive a securing member 3.8 of the actuator described below. The bolt extracting plate 8 has two extensions 8.1A and 8.1B which extend into tines 8.4A and 8.4B. Two pairs of protrusions 8.2A and 8.2B and 8.3A and 8.3B extend perpendicularly laterally from the bolt extracting plate 8 toward the top plate 3 as will be described herein. The protrusions interact with the cam 4 to retract the latch-bolt head assembly 1 into the latch-bolt case 2 described below.

The actuator assembly 200 comprises a top plate 3, a bottom plate 7, an outside latch cover or box cover 6, a cam 4, and a washer 5. The cam 4 and the washer 5 are positioned between the front plate 3 and the back plate 7, and the combination of the front plate and back plate are enclosed by outside latch cover or box cover 6 as described herein.

Referring to FIG. 3, the cam 4 comprises a cam cylindrical body 4.4 divided into portion 4.4A and a second portion 4.4B. Portions 4.1A and 4.1B extend axially out from the cylindrical body 4.4 along the axis of rotation and have cam following surfaces 4.5A and 4.5B which engage the protrusions 8.2A, 8.2B, 8.3A or 8.3B. The cylindrical body portion 4.4A has two parallel flat sides or flats 4.4AA and 4.4BB. The cylindrical body has a square hole 4.2 coaxial with the axis of rotation of the cam which can receive a square shaft or square spindle (not shown). The cam is rotated with door knobs or door levers attached to a square spindle which extends through the cam. When the knob or cam are rotated, the cam is rotated and the bolt extraction plate 8 is pulled out of the case 2 to retract the bolt 1.1 and the trigger bolt 1.2 into the latch-bolt case 2. Configuration and operation of a tubular door lock with the door knob and the spindle is illustrated in U.S. Pat. Nos. 6,030,008; 5,335,950; 5,257,837; 5,169,184; and 4,470,278 whose disclosures are incorporated by reference herein. The cam has two fingers or teeth 4.1A and 4.1B, respectively.

The washer 5 rides on the portion 4.4A of the cylindrical body of the cam. The washer has an oblong hole 5.1 which matches the cross section of the portion 4.4A of the cylindrical body 4.4 of the cam. The washer rotates with the cam since it is captured on portion 4.4A. The washer is arched or curved, and not planar, to bias the cam 4 toward the bottom plate 7.

Top plate 3 has openings 3.1 and 3.2 and notch 3.3 for receiving the mounting posts of the door rose assembly which normally comprises a cover, a liner on which the mounting posts extend and the door knob or door lever. Door knob assemblies are described in U.S. Pat. Nos. 4,927,199; 5,335,950; 5,551,736; 6,030,008; 6,293,597; 6,633,635; 4,470,278; 4,711,477, the disclosures of which are herein incorporated by reference. The mounting posts normally have internally threaded orifices for receiving threaded screws which extend from the opposing door rose assembly through the cover and through its liner and secures the rose assemblies on either side of the door by tension and helps keep the door set or tubular door lock in position within the door by virtue of the mounting posts extending through holes 3.1 or 3.2 and notch 3.3 of the top plate and hole 7.1 or 7.2 and notch 7.3 of the back plate 7 and notches 6.3A and 6.3B of the box 6. The top plate 3 has two pairs of holes 3.5A and 3.5B and 3.6A and 3.6B which are adapted to receive inwardly extending half-round protuberances 6.2A and 6.2B of the outside latch cover 6 which maintains registration of the latch cam for a selected backset. In other words, the holes 3.5A and 3.5B are positioned such that when protuberances 6.2A and 6.2B of the box cover 6 engage the holes, the cam 4 is positioned at the anterior ends of elongated holes 3.4 and 7.4 and is positioned for a 2⅜ inch setback. The holes 3.6A and 3.6B are positioned such that when they are engaged by protuberances 6.2A and 6.2B, the cam 4 is positioned at the posterior ends of elongated holes 3.4 and 7.4 and is positioned for a backset of 2¾ inches. Although the holes 3.5A, etc., can be holes, they can also be half-round indents which can receive half-round protuberances 6.2A and 6.2B. The top plate has a gourd-shaped elongated hole 3.4 which has a narrow or constricted portion with parallel sides 3.4AA and 3.4BB. The ends of the elongated hole are adapted to receive for rotation the 4.4A portion of the cylindrical body of the cam, while the narrow or constricted portion of hole 3.4 permits passage of the 4.4A portion of the cam between either ends of hole 3.4 with the opposing parallel flats 4.4AA and 4.4BB parallel to the longitudinal axis of the hole and riding on the parallel sides 3.4AA and 3.4BB of hole 3.4. At the posterior end of plate 3 on either side of the notch 3.3 are located slots 3.7A and 3.7B for receiving the ends of extensions or fingers 7.5A and 7.5B, respectively, of the bottom plate 7. Slots 3.7A and 3.7B and fingers 7.5A and 7.5B keep the top plate 3 and the bottom plate 7 in registration longitudinally and the outside latch cover 6 keeps the top plate and bottom plate in registration vertically.

Bottom plate 7 has two holes 7.1 and 7.2 and notch 7.3 which are axially aligned with holes 3.1 and 3.2 and notch 3.3 of the top plate when the actuator assembly 200 is fully assembled. Holes 7.1 or 7.2 and notch 7.3 are adapted to receive the mounting posts of a door lock rose assembly in the same manner that holes 3.1 and 3.2 and notch 3.3 of the top plate 3 are as described above.

The center end of plate 3 has a securing member 3.8 which is received in notch 2.3 of the rear wall 2.2 of the latch-bolt case 2.

Bottom plate 7 has an elongated hole 7.4 which has the same width as the diameter of portion 4.4B of the cylindrical body 4.4 of the cam 4. The portion 4.4B of the cylindrical body is adapted to move from one end to the other end of elongated hole 7.4 and to rotate within hole 7.4. Teeth 4.1A or 4.1B of the cam extend out beyond planes of the side walls 7.8A or 7.8B of bottom plate. At the posterior end of plate 7 extending laterally outward are the extensions or fingers 7.5A and 7.5B which extend laterally to top plate 3 through slots 3.7A and 3.7B of plate 3 as described above. At the anterior end of plate 7, there are a pair of fingers 7.6A and 7.6B which extend through opening 2.1 in the rear wall of the latch-bolt case 2 to secure plate 7 to the posterior wall 2.2 of the latch-bolt case. When top plate 3 is mounted on the bottom plate 7, cam 4 rides between them in elongate opening 3.4 and 7.4 as described above. The washer 5 is positioned between cam 4 and inner side of plate 3 and biases the cam against the inner side of plate 7 to keep the position of the cam 4 with respect to its axis of rotation perpendicular to the sides of plate 3 and plate 7.

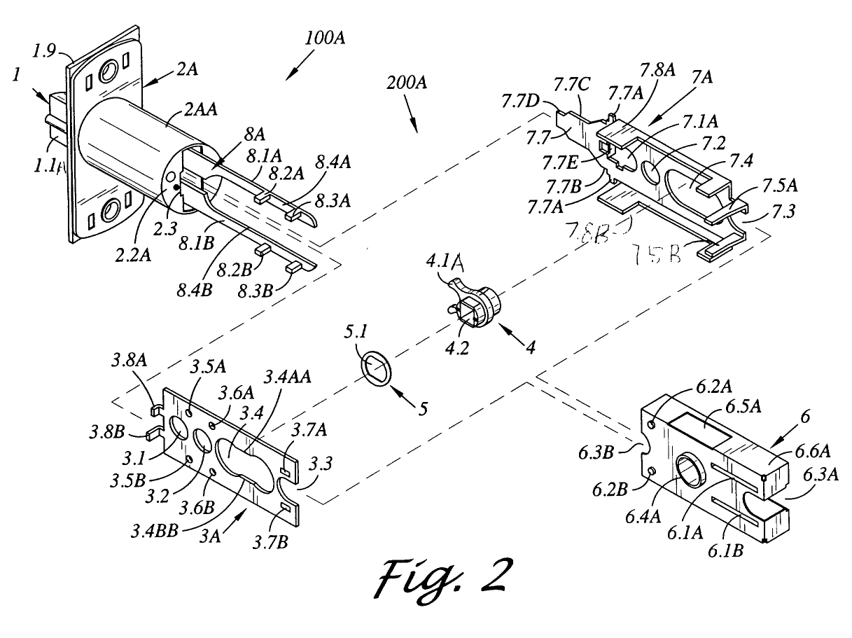

The outside latch cover or box cover 6 has two slots on its posterior end on sides shown in FIG. 1 and FIG. 2 which extend longitudinally a little less than half way along the length of the cover. The ends of fingers 7.5A and 7.5B of plate 7 extend through the slots and engage the posterior end of the slots when the tubular door lock has been set for a backset of 2¾ inches and rest on the anterior end of the slots when the backset has been set for 2⅜ inches. The cover has notches 6.3A and 6.3B at the posterior end and anterior end, respectively. Notch 6.3A lines up with notches 3.3 and 7.3 when the cover has been moved forward to have the fingers 7.5A and 7.5B rest on the posterior end of groove 6.1A and 6.1B. The anterior notch 6.3B lines up with the posterior end of holes 3.1 and 7.1 when the cover has been moved forward as just described. When the cover is moved back so that the fingers 7.5A and 7.5B engage or stop on the anterior ends of slots 6.1A and 6.1B, the notch 6.3B is aligned with the posterior ends of holes 3.2 and 7.2. These notches permit the mounting posts of a door rose assembly to extend through the actuator assembly 200 when the lock is assembled in the door. At the anterior end of the box cover 6 on the side of the cover illustrated in FIG. 1 are two half-round protuberances 6.2A and 6.2B which extend inwardly and are adapted to engage either hole set 3.5A and 3.5B or 3.6A and 3.6B when the cover has been slid fully forward or fully backward, respectively, as permitted by the grooves 6.1 and the fingers 7.5.

It is to be noted that the present invention permits two ways of placing the cam 4 in registration for either a 2¾ setback or 2⅜ setback. The protrusions 6.2 and holes 3.5 or 3.6 register the position of the cam with respect to the proper setback. Likewise, the slots 6.1 and the fingers 7.5 when the fingers are resting on either the posterior and/or the anterior end of the slots register the cam with respect to the appropriate setback. The present invention can be made either with the fingers and slots or with the holes and protuberances, or with both as illustrated. Moreover, the present invention can be made with a single set of registration elements. For example, the device can be made with merely holes 3.5A and 3.6A and not with the additional holes 3.5B and 3.6B. Alternatively, the invention can be made with a single protuberance, either 6.2A or 6.2B. In another embodiment, the registration holes can be in the box cover and the protuberances can be extending outwardly toward the box cover from a frame plate. In still another embodiment, the registration hole[s] and the corresponding registration protuberance for that hole[s] can be on a frame plate and the box cover, respectively, and the registration hole[s] for the other backset position and the corresponding registration protuberance for that hole can be on the box frame and a frame plate, respectively. In another embodiment, the invention can be made with a single finger, either 7.5A or 7.5B. In a third alternative, the invention can be made with a single slot, either 6.1A or 6.1B. In the latter case, the device will then only have a single finger, the finger that rides in the existing slot. In another embodiment of the present invention, the fingers can extend from the posterior end of the top plate toward the bottom plate with the bottom plate having slots corresponding to slots 3.7A and 3.7B. In this embodiment, the grooves 6.1A and 6.1B will be on the other side, the bottom side, of the box cover 6. Similarly, the holes corresponding to holes 3.5A, 3.5B, 3.6A, and 3.6B can be placed in the bottom plate 7 with the protuberances 6.2A and 6.2B being on the other side, the bottom side, of the box cover 6. For purposes of clarification, the top wall of the box cover 6 is the facing wall in FIGS. 1 and 2. The bottom wall is the opposing wall which is not shown in FIGS. 1 and 2. The top plate rides on the inner side of the top wall of the box cover and the bottom plate 7 rides against the inner side of the bottom wall of the box cover.

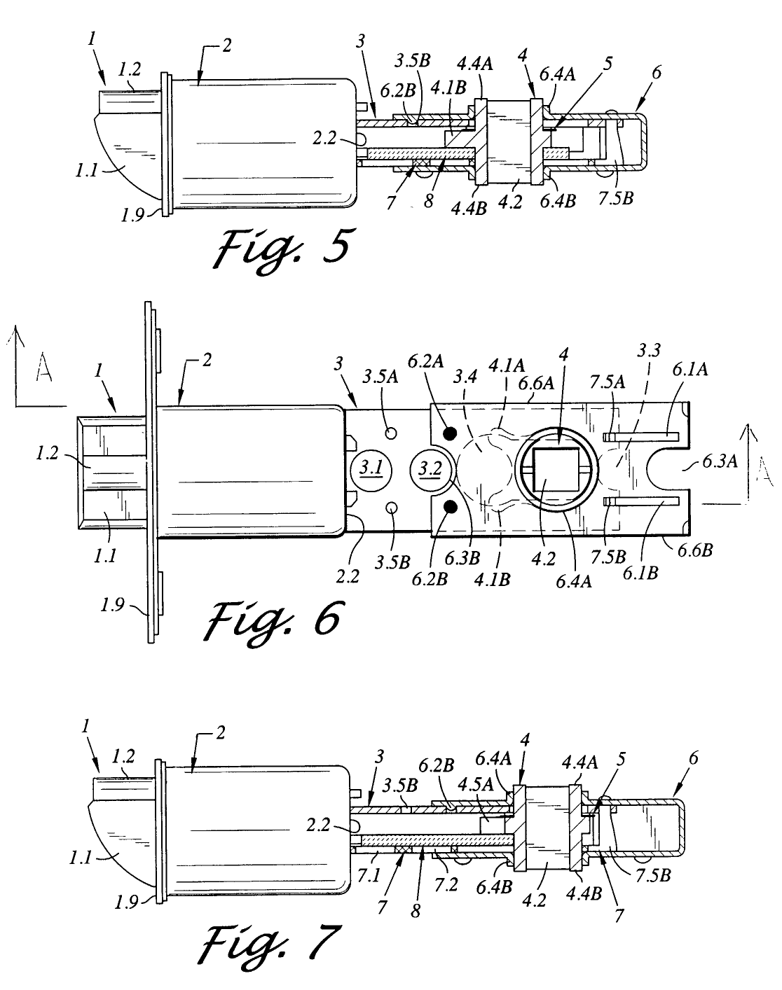

The outside latch cover 6 includes two bushings 6.4A and 6.4B (see FIGS. 5 and 7). The portion 4.4A of the cylindrical body of the cam rides in bushing 6.4A and the portion 4.4B of the cylindrical body of the cam rides in bushing 6.4B. The cam rides in and rotates within the bushings, and the bushings and the outside latch cover maintain the vertical and horizontal orientation of the cam within the actuator assembly and maintain the position of the cam with regard to the proper backset. The outside latch cover 6 also includes window 6.5A on the top of the cover and another similar window (not shown) on the bottom of the cover to permit the teeth 4.1A and 4.1B, respectively, of the cam to extend beyond the plane of the wall 6.6A or bottom wall 6.6B (see FIGS. 4 and 6) of the cover.

With regard to FIG. 2, the outward appearance of deadbolt assembly 100A appears similar to deadbolt assembly 100 FIG. 1. However, deadbolt assembly 100A is made for locks having a 45° opening angle assembly, the type normally used with door levers rather than door knobs. The deadbolt assembly 100 of FIG. 1 is the type made for 90° open angle, the type normally used with door knobs. The latch-bolt head assembly 1A within the latch-bolt case 2 of deadbolt assembly 100A is different than the latch-bolt extractor assembly 1 of deadbolt assembly 100 of FIG. 1. Thus, the latch-bolt extractor assemblies 1 and 1A of the deadbolt assembly 100 and 100A are different and this is manifested in differences in the front plate and bottom plate 3A and 7A of actuator assembly 200A shown in FIG. 2. With regard to the top plate 3A, at the anterior end of top plate 3A, there are two securing members 3.8A and 3.8B. In all other respects, plate 3 is identical to 3A. With regard to plate 7A, at the anterior end, there is an extension member 7.7 having opposing ears 7.7A, opposing first step 7.7B, opposing second steps 7.7C, and an end extension 7.7D. At the posterior end of the extension member 7.7, there is a outwardly extending tab 7.7E which extends traversely outward opposite to fingers 7.5A and 7.5B. Hole 7.1A is slightly elongated because tab 7.7E is formed out of one side of it. However, hole 7.1A is aligned with hole 3.1 of frame plate 3. The rear wall 2.2A of the case 2AA is slightly different from the rear wall 2 of FIG. 1 because of the differences in the latch bolt head assembly 1A. In all other respects, bottom plate 7 is virtually identical to bottom plate 7A. The anterior position of the bolt extraction plate 8A within the case 2AA is slightly different than the anterior position of the bolt extraction plate 8 of FIG. 1 because of the differences in the latch bolt head assembly 1A. All other elements of the deadbolt assembly 100A and actuator assembly 200A are identical to like numbered elements in FIG. 1.

The actuator assemblies 200 or 200A and deadbolt assemblies 100 or 100A are assembled together and supplied together as a single unit or as a tubular door lock or tubular lock as illustrated in FIGS. 4 through 8. FIGS. 4 and 5 show the tubular door lock positioned for 2⅜ inch backset with the outside latch cover 6 pushed completely forward toward case 2. As illustrated in FIGS. 4 and 5, protuberances 6.2A and 6.2B are engaging hole set 3.5A and 3.5B, and fingers 7.5A and 7.5B are stopped against the posterior ends of slots 6.1A and 6.1B, respectively. The cam 4 riding in bushings 6.4A and 6.4B of the cover is pushed fully forward in elongated holes 3.4 and 7.4 (not shown). The tubular door lock is shown in the locked position with the bolt 1.1 extending outward from the latch-bolt case 2. The teeth or fingers 4.1A and 4.1B are pointed forward toward the front of the lock assembly. In the position shown, the mounting bolts of the rose assembly of the door lock will be extending through hole 3.1 and hole 7.1 (not shown), and notch 6.3A and notches 3.3 and 7.3 of plates 3 and 7 (not shown).

When the lock is to be utilized with a backset of 2¾ inches, the cover 6 is pulled back away from case 2 to its most rearward position, wherein protrusion 6.2A and 6.2B engage hole set 3.6A and 3.6B of plate 3. The fingers 7.5A and 7.5B ride stopped against the anterior end of slots 6.1A and 6.1B, respectively. As shown in FIG. 6, the bolt 1.1 extends outwardly from the latch-bolt case 2. The teeth or fingers of the cam 4.1A and 4.1B are pointing directly forward. With a 2¾ inch backset, the mounting posts of the rose assemblies of the door locks would extend through notch 6.3B and hole 3.2 of plate 3 and hole 7.2 of plate 7 (not shown) and notch 6.3A. The cam 4 which is riding in bushings 6.4A and 6.4B is positioned at the posterior end of the elongated holes 3.4 of plate 3 and 7.4 of plate 7 (not shown).

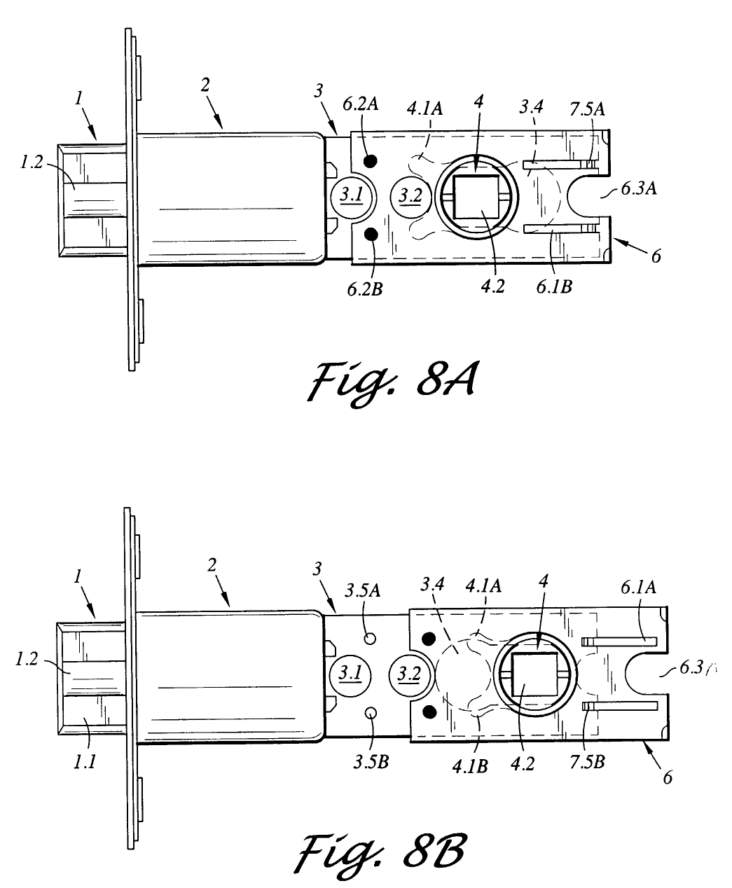

FIG. 8A and FIG. 8B show the tubular door lock assemblies in the 2-3/8 setback and 2¾ setback positioned respectively.

Referring to FIG. 9, this shows a tubular door lock in the 2⅜ inch setback position employing a deadbolt assembly 100 for a 90° opening angle. This is the type of tubular door lock that would be employed with a door knob in contrast to a lever. It is awkward to move a lever though about 90° to open a door whereas it is easy to rotate a door knob 90°. In FIG. 9, the deadbolt assembly 100 on the left side is rotated 90° along the longitudinal axis of the tubular door lock with respect to the actuator assembly 200.

FIG. 9 shows the tubular door lock in unlocked position with the latch-bolt head assembly in fully retracted position, that is the position wherein the bolt 1.1 and the dead latch-bolt or trigger bolt 1.2 are fully retracted into the latch-bolt case 2. The door lock is opened by turning a door knob which is secured to a square spindle or square shaft which extends through square opening 4.2 of the cam 4. The cam rotates with the door knob. The cam rotates in the bushings 6.4A and 6.4B of the outside latch cover describe above. As shown in FIG. 9, the cam has been rotated in the clockwise direction and the cam teeth 4.1A has engaged protuberance 8.2A forcing the extension 8.1A of the bolt extracting plate 8 backward away from the case 2. If the door knob having rotated counterclockwise, tooth 4.1B would have engaged protuberance 8.2B forcing the extension 8.1B of the bolt extracting plate 8 backwards away from case 2. If the tubular door lock had been set for a 2¾ inch backset, and the door knob had been turned clockwise, the tooth 4.1A would have engaged protuberance 8.3A. Similarly, if the backset was 2¾ inch and the knob was turned counterclockwise, tooth 4.1B would have engaged protuberance 8.3B and forced the extension 8.1B of the bolt extracting 8 backwards away from the case 2. In any of the four cases, the rotation of the cam would retract the bolt 1.1 and trigger bolt 1.2 into the case unlocking or opening the lock.

Referring to the left side of the figure, the 90° opening angle latch-bolt head assembly 100 consists of a latch-bolt 1.1 riveted to the connecting plate 1.7 and trigger bolt 1.2 is connected to trigger bolt stop plate 1.6 and the trigger bolt spring 1.4. In addition, the trigger bolt 1.2 is connected to a trigger bolt frame 13 and trigger bolt stop plate 1.6. When the cam of the actuator assembly is rotated, it forces the bolt extracting plate 8 backwards away from the latch-bolt case 2 which draws connecting plate 1.7 and trigger bolt frame 13 backwards retracting bolt 1.1 and trigger bolt 1.2 into the case 2. When the bolt 1.1 and the trigger bolt 1.2 are retracted into the case, trigger bolt spring 1.4 and bolt spring 1.8 are compressed. When the door knob or door handle is released, they are spring biased to bring the door knob or door handle to a neutral position which brings the cam into a neutral position with the cam teeth pointing forward. This releases the backward force on the bolt extraction plate 8 permitting the bolt spring 1.8 and the trigger bolt spring 1.4 to force out the bolt 1.1 and the trigger 1.2 and to draw bolt extraction plate 8 forward toward the case 2 via connecting plate 1.7 and trigger bolt frame 1.3. Although it is convenient to discuss tubular door locks having 90° openings, it is well-known that the actual angle degree can vary anywhere from 45° over 100° depending upon the manufacturer. In the case illustrated in FIG. 9, angle alpha, the opening angle for the cam is only about 72°.

Referring to FIG. 10, this shows the deadbolt assembly 100 in a locking position wherein the cam 4 is in the neutral position with both teeth 4.1A and 4.1B extending straight forward. The spring 1.8 has returned the bolt 1.1 to a locking position and spring 1.4 has returned the trigger bolt to the full forward position. Trigger bolt frame 1.3 and the latch-bolt connecting plate 1.7 connected to the trigger bolt and the bolt, respectively, have moved the bolt extracting plate 8, which is now free to move since the cam teeth are no longer engaging in the protrusions of plate 8, forward. In the installed door locked position, when the tubular door lock is installed in a door, and the door is closed, with the tubular door lock engaging the door strike plate in the conventional manner, the bolt 1.1 extends into the bolt of the strike plate and the strike plate (not shown) prevents the trigger bolt from extending out of the case 2. Thus, in the locked position, the trigger bolt spring is still compressed even though the strike plate may extend slightly out of the case because of the distance between the strike plate and the front plate of the tubular door lock. The trigger bolt spring 1.4 when under compression biases the trigger bolt stop plate 1.6 to engage gage the rear surface of bolt 1.1 preventing the bolt 1.1 from being jimmied into the latch bolt case 2. When the tubular door lock is open by having the door knob rotated or the door lever rotated downwardly, which causes the cam to pull the bolt extracting plate 8 rearward, trigger bolt stop plate 1.6 disengages the rear surface of the bolt 1.1 permitting the bolt 1.1 together with the trigger bolt 1.2 to be retracted into the case 2 by the bolt extraction plate via latch bolt connecting plate 1.7 and trigger bolt frame 1.3.

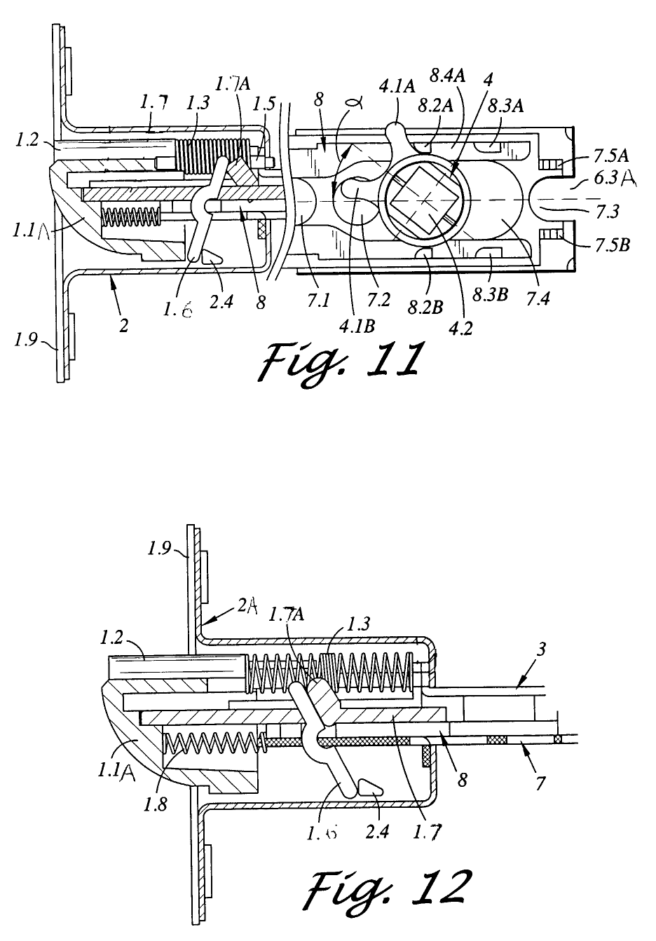

Referring to FIGS. 11 and 12, the tubular door lock of these figures is for a 45° opening angle assembly. The tubular door lock is shown for a 2⅜ inch setback. Although the opening is nominally referred to as 45°, in the lock shown here, the opening requires a rotation of about 37° of the cam 4. The cam is attached to a square spindle (not shown) which in turn is attached to a door lever. Rarely are door knobs secured to a 45° opening assembly. The cam has been rotated only about clockwise 37° and has engaged protrusion 8.2A of the bolt extracting plate 8 and has moved the plate backwards or rearwards. Referring to the left side of FIG. 11, the deadbolt assembly 100A is illustrated. The actuator assembly 200A and the deadbolt assembly 100A are rotated 90° with respect to each other along the longitudinal axis to better illustrate the operation of the tubular door lock assembly. The deadbolt assembly 100A is for a 45° opening angle latch-bolt assembly and consists of a latch-bolt 1.1 riveted to the latch bolt connection 1.7 which contacts the top of the lever arm 1.6 which abuts against indent 2.4 in the case 2 and is connected to plate 8 for longitudinal movement. When plate 8 is moved rearward or backward, retracting or drawing back connecting plate 1.7 to retract bolt 1.1A and trigger bolt 1.2 into the case 2. Retraction of the bolt and the trigger bolt compress springs 1.3 and 1.8 which bias the bolt and the trigger bolt outward from the case into the locking position. When the door knob or lever is released, the springs 1.3 and 1.8 drive the bolt 1.1A and the trigger bolt 1.2 forward out of the case into the extended position shown in FIG. 12. The springs via lever arm 1.6 lever also draws the bolt extracting plate 8 forward. The lever arm 1.6 abuts stop 2.4 at its lower end for rotation and abuts projection 1.7A at its upper end.

I claim

1. A dual backset tubular door lock comprising a latch-bolt assembly and a connected actuator assembly:
the latch-bolt assembly having a bolt case with an anterior face plate and posterior wall, the posterior wall having a hole, a bolt extendible out of the anterior face plate and retractable into the bolt case, retracting means within the case connected to the bolt, and a bolt extracting plate having an anterior portion and a posterior portion with two longitudinal spaced apart tines, a set of protuberances extending laterally from each tine, the bolt extracting plate extending through the hole in the posterior wall with the anterior portion of the bolt extracting plate within the case and connected to the retracting means and the posterior portion extending out from the posterior wall, the bolt being retracted into the bolt case when the posterior portion of the bolt extracting plate is moved posteriorly away the bolt case and extended out from the case when the posterior portion is moved anteriorly towards the bolt case;
the actuator assembly having an anterior end and posterior end with the anterior end secured to the posterior wall of the bolt case, top and bottom frame plates having anterior ends and posterior ends, a cam, and a box cover, the frame plates having means for securing their anterior ends to the posterior wall of the bolt case, the frame plates having axially aligned notches and holes to receive mounting posts of a door lock rose, and axially aligned elongated holes having longitudinal axes;
the cam having a cylindrical body with first and second portions adapted to be received in the elongated holes of the frame plates and to rotate therein and two teeth with cam surfaces adapted to engage the protuberances on the tines of the bolt extracting plate, the cylindrical body having a hole coaxial with its axis of rotation adapted to received a door lock spindle for rotation of the cam, the cam positioned between the frame plates and adapted to be moved longitudinally within the elongated holes;
the posterior portion of the bolt extraction plate positioned between one of the frame plates and the cam with the first portion of the cylindrical body positioned between the two tines, the protuberances extending away from the tines towards the other frame plate, each protuberance adapted to be engaged by a cam tooth; and
the box cover having an anterior end and posterior end, parallel side walls, parallel top and bottom walls, and an open anterior end, the top and bottom walls having a posterior and anterior notches to receive mounting posts of a door lock rose, the notches being axially aligned when the box cover is positioned at the either backset position with the notches and holes of the frame plates, the top and bottom walls having axially aligned bushings to receive for rotation the first and second portions of the cylindrical body of the cam, the frame plates positioned within the box cover with the exterior sides of the top and bottom frame plates adjacent the inner sides of the top and bottom walls of the box cover respectively, the box cover adapted to longitudinally slide over the frame plates.

2. The dual backset tubular door lock according to claim 1 wherein the actuator assembly includes a an washer having adapted to be received on the cylindrical body of the cam, the washer mounted on one of the two portions of the cylindrical body between the cam teeth and one of the frame plates.

3. The dual backset tubular door lock according to claim 2 wherein the washer is arched shape and biases the cam against one of the frame plates.

4. The dual backset tubular door lock according to claim 1 wherein the first portion of the cylindrical body has the two parallel flats are parallel, the elongated hole of a frame plate is gourd shape with the center portion of the elongated hole between its ends constricted to only receive the first portion of the cylindrical body when the two parallel flats are parallel to the longitudinal axis of the elongated hole to align the cam with its teeth pointing forward, and the washer having an oblong hole adapted to be received by the first portion of the cylindrical body of the cam and to rotate with the cam.

5. The dual backset tubular door lock according to claim 4 wherein the washer is arch shaped.

6. The dual backset tubular door lock according to claim 4 wherein the washer is wave shaped.

7. The dual backset tubular door lock according to claim 1 wherein the first portion of the cylindrical body has the two parallel flats are parallel, and the elongated hole of a frame plate is gourd shape with the center portion of the elongated hole between its ends constricted to only receive the first portion of the cylindrical body when the two parallel flats are parallel to the longitudinal axis of the elongated hole to align the cam with its teeth pointing forward.

8. The dual backset tubular door lock according to claim 1 wherein one of the frame plates has at least two registrations holes, and the wall of the box frame adjacent the frame plate having the two registration holes having at least one registration protuberance extending toward the frame plate and positioned to engage one registration hole when the box cover is slid to one back set position and to engage the other registration hole when the box cover is slid to the other back set position.

9. The dual backset tubular door lock according to claim 1 wherein the top or bottom wall of the box cover has at least two registration holes, and the frame plate adjacent the wall of the box cover having two registration holes having at least one registration protuberance extending toward the box cover and positioned to engage one registration hole when the box cover is slid to one back set position and to engage the other registration hole when the box cover is slid to the other back set position.

10. The dual backset tubular door lock according to claim 1 wherein one of the frame plates having at least one finger near its posterior end extending to the other frame plate, the other frame plate having at least one finger slot near its posterior end, each finger extending to and through a separate finger slot in the other frame plate, one of the top or bottom walls of the box cover having at least one elongated slot near its posterior end, each finger extending through a separate elongated slot and adapted to move along the length thereof when box cover is slide from one backset position to the other backset position, at least one finger engaging one end of an elongated slot when the cover is slid to one backset position and at least one finger engaging the other end of an elongated slot when the box cover is slid to the other backset position,

11. The dual backset tubular door lock according to claim 1 wherein one of the frame plates having at two fingers near its posterior end extending to the other frame plate, the other frame plate having two finger slots near its posterior end, each finger extending to and through a separate finger slot in the other frame plate, one of the top or bottom walls of the box cover having two elongated slot near its posterior end, each finger extending through a separate elongated slot and adapted to move along the length thereof when box cover is slide from one backset position to the other backset position, at least one finger engaging one end of an elongated slot when the cover is slid to one backset position and at least one finger engaging the other end of an elongated slot when the box cover is slid to the other backset position,

12. A dual backset tubular door lock comprising a latch-bolt assembly and a connected actuator assembly:
the latch-bolt assembly having a bolt case with an anterior face plate and posterior wall, the posterior wall having a hole, a bolt extendible out of the anterior face plate and retractable into the bolt case, retracting means within the case connected to the bolt, and a bolt extracting plate having an anterior portion and a posterior portion with two longitudinal spaced apart tines, a set of protuberances extending laterally from each tine, the bolt extracting plate extending through the hole in the posterior wall with the anterior portion of the bolt extracting plate within the case and connected to the retracting means and the posterior portion extending out from the posterior wall, the bolt being retracted into the bolt case when the posterior portion of the bolt extracting plate is moved posteriorly away the bolt case and extended out from the case when the posterior portion is moved anteriorly towards the bolt case;
the actuator assembly having an anterior end and posterior end with the anterior end secured to the posterior wall of the bolt case, top and bottom frame plates having anterior ends and posterior ends, a cam, and a box cover, the frame plates having means for securing their anterior ends to the posterior wall of the bolt case, the frame plates having axially aligned notches and holes to receive mounting posts of a door lock rose, and axially aligned elongated holes having longitudinal axes, the elongated hole of one frame plate being gourd shape with the center portion of the elongated hole between its ends constricted to only receive the first portion of the cylindrical body when the two parallel flats are parallel to the longitudinal axis of the elongated hole to align the cam with its teeth pointing forward, one of the frame plates having at least one finger near its posterior end extending to the other frame plate, the other frame plate having at least one finger slot near its posterior end, each finger extending to and through a separate finger slot in the other frame plate, at least one of the frame plates having at least two registration holes longitudinally spaced apart;
the cam having a cylindrical body with first and second portions adapted to be received in the elongated holes of the frame plates and to rotate therein and two teeth with cam surfaces adapted to engage the protuberances on the tines of the bolt extracting plate, the cylindrical body having a hole coaxial with its axis of rotation adapted to received a door lock spindle for rotation of the cam, the first portion of the cylindrical body having two parallel flats, the cam positioned between the frame plates and adapted to be moved longitudinally within the elongated holes;
the posterior portion of the bolt extraction plate positioned between one of the frame plates and the cam with the first portion of the cylindrical body positioned between the two tines, the protuberances extending away from the tines towards the other frame plate, each protuberance adapted to be engaged by a cam teeth; and
the box cover having an anterior end and posterior end, parallel side walls, parallel top and bottom walls, and an open anterior end, the top and bottom walls having a posterior and anterior notches to receive mounting posts of a door lock rose, the notches being axially aligned when the box cover is positioned at the either backset position with the notches and holes of the frame plates, the top and bottom walls having axially aligned bushings to receive for rotation the first and second portions of the cylindrical body of the cam, at least one of the top or bottom walls having at least one elongated slot near its posterior end, each finger extending through a separate elongated slot, towards and away from the bolt case, each finger extending through an elongated slot and adapted to move along the length thereof when box cover is slide from one backset position to the other backset position, at least one finger engaging one end of an elongated slot when the cover is slid to one backset position and at least one finger engaging the other end of an elongated slot when the box cover is slid to the other backset position, the frame plates positioned within the box cover with the exterior sides of the top and bottom frame plates adjacent the inner sides of the top and bottom walls of the box cover respectively, the box cover adapted to longitudinally slide over the frame plates, the wall of the box frame adjacent the frame plate having the two registration holes having at least one protuberance extending toward the frame plate and positioned to engage one registration hole when the box cover is slid to one back set position and to engage the other registration hole when the box cover is slid to the other back set position.

13. The dual backset tubular door lock of claim 12 wherein the actuator assembly includes an arch-shaped washer having an oblong hole adapted to be received by the first portion of the cylindrical body of the cam and to rotate with the cam, first portion of the cylindrical body having two parallel flats, and the washer mounted on the first portion between the cam teeth and one of the frame plates.

14. A dual backset tubular door lock comprising a latch-bolt assembly and a connected actuator assembly:
the latch-bolt assembly having a bolt case with an anterior face plate and posterior wall, the posterior wall having a hole, a bolt extendible out of the anterior face plate and retractable into the bolt case, retracting means within the case connected to the bolt, and a bolt extracting plate having an anterior portion and a posterior portion with two longitudinal spaced apart tines, a set of protuberances extending laterally from each tine, the bolt extracting plate extending through the hole in the posterior wall with the anterior portion of the bolt extracting plate within the case and connected to the retracting means and the posterior portion extending out from the posterior wall, the bolt being retracted into the bolt case when the posterior portion of the bolt extracting plate is moved posteriorly away the bolt case and extended out from the case when the posterior portion is moved anteriorly towards the bolt case;
the actuator assembly having an anterior end and posterior end with the anterior end secured to the posterior wall of the bolt case, top and bottom frame plates having anterior ends and posterior ends, a cam, a washer, and a box cover, the frame plates having means for securing their anterior ends to the posterior wall of the bolt case, the frame plates having axially aligned notches and holes to receive mounting posts of a door lock rose, and axially aligned elongated holes having longitudinal axes, one of the frame plates having at least one finger near its posterior end extending to the other frame plate, the other frame plate having at least one finger slot near its posterior end, each finger extending to and through a separate finger slot in the other frame plate, at least one of the frame plates having at least two registration holes longitudinally spaced apart;
the cam having a cylindrical body with first and second portions adapted to be received in the elongated holes of the frame plates and to rotate therein and two teeth with cam surfaces adapted to engage the protuberances on the tines of the bolt extracting plate, the cylindrical body having a hole coaxial with its axis of rotation adapted to received a door lock spindle for rotation of the cam, the cam positioned between the frame plates and adapted to be moved longitudinally within the elongated holes;
an arch-shaped washer having an oblong hole adapted to be received by the first portion of the cylindrical body of the cam and to rotate with the cam, the washer mounted on the first portion between the cam teeth and one of the frame plates;
the posterior portion of the bolt extraction plate positioned between one of the frame plates and the cam with the first portion of the cylindrical body positioned between the two tines, the protuberances extending away from the tines towards the other frame plate, each protuberance adapted to be engaged by a cam teeth; and
the box cover having an anterior end and posterior end, parallel side walls, parallel top and bottom walls, and an open anterior end, the top and bottom walls having a posterior and anterior notches to receive mounting posts of a door lock rose, the notches being axially aligned when the box cover is positioned at the either backset position with the notches and holes of the frame plates, the top and bottom walls having axially aligned bushings to receive for rotation the first and second portions of the cylindrical body of the cam, at least one of the top or bottom walls having at least one elongated slot near its posterior end, each finger extending through a separate elongated slot, towards and away from the bolt case, each finger extending through an elongated slot and adapted to move along the length thereof when box cover is slide from one backset position to the other backset position, at least one finger engaging one end of an elongated slot when the cover is slid to one backset position and at least one finger engaging the other end of an elongated slot when the box cover is slid to the other backset position, the frame plates positioned within the box cover with the exterior sides of the top and bottom frame plates adjacent the inner sides of the top and bottom walls of the box cover respectively, the box cover adapted to longitudinally slide over the frame plates, the wall of the box frame adjacent the frame plate having the two registration holes having at least one protuberance extending toward the frame plate and positioned to engage one registration hole when the box cover is slid to one back set position and to engage the other registration hole when the box cover is slid to the other back set position.

15. The dual backset tubular door lock according to claim 14 wherein the first portion of the cylindrical body having two parallel flats. And the elongated hole of one of the frame plates being gourd shape with the center portion of the elongated hole between its ends constricted to only receive the first portion of the cylindrical body when the two parallel flats are parallel to the longitudinal axis of the elongated hole to align the cam with its teeth pointing forward.

16. A dual backset tubular door lock comprising a latch-bolt assembly and a connected actuator assembly:
the latch-bolt assembly having a bolt case with an anterior face plate and posterior wall, the posterior wall having a hole, a bolt extendible out of the anterior face plate and retractable into the bolt case, retracting means within the case connected to the bolt, and a bolt extracting plate having an anterior portion and a posterior portion with two longitudinal spaced apart tines, a set of protuberances extending laterally from each tine, the bolt extracting plate extending through the hole in the posterior wall with the anterior portion of the bolt extracting plate within the case and connected to the retracting means and the posterior portion extending out from the posterior wall, the bolt being retracted into the bolt case when the posterior portion of the bolt extracting plate is moved posteriorly away the bolt case and extended out from the case when the posterior portion is moved anteriorly towards the bolt case;
the actuator assembly having an anterior end and posterior end with the anterior end secured to the posterior wall of the bolt case, top and bottom frame plates having anterior ends and posterior ends, a cam, a washer, and a box cover, the frame plates having means for securing their anterior ends to the posterior wall of the bolt case, the frame plates having axially aligned notches and holes to receive mounting posts of a door lock rose, and axially aligned elongated holes having longitudinal axes, the elongated hole of one frame plate being gourd shape with the center portion of the elongated hole between its ends constricted to only receive the first portion of the cylindrical body when the two parallel flats are parallel to the longitudinal axis of the elongated hole to align the cam with its teeth pointing forward, at least one of the frame plates having at least two registration holes longitudinally spaced apart;
the cam having a cylindrical body with first and second portions adapted to be received in the elongated holes of the frame plates and to rotate therein and two teeth with cam surfaces adapted to engage the protuberances on the tines of the bolt extracting plate, the cylindrical body having a hole coaxial with its axis of rotation adapted to received a door lock spindle for rotation of the cam, the first portion of the cylindrical body having two parallel flats, the cam positioned between the frame plates and adapted to be moved longitudinally within the elongated holes;
an arch-shaped washer having an oblong hole adapted to be received by the first portion of the cylindrical body of the cam and to rotate with the cam, the washer mounted on the first portion between the cam teeth and one of the frame plates;
the posterior portion of the bolt extraction plate positioned between one of the frame plates and the cam with the first portion of the cylindrical body positioned between the two tines, the protuberances extending away from the tines towards the other frame plate, each protuberance adapted to be engaged by a cam teeth; and
the box cover having an anterior end and posterior end, parallel side walls, parallel top and bottom walls, and an open anterior end, the top and bottom walls having a posterior and anterior notches to receive mounting posts of a door lock rose, the notches being axially aligned when the box cover is positioned at the either backset position with the notches and holes of the frame plates, the top and bottom walls having axially aligned bushings to receive for rotation the first and second portions of the cylindrical body of the cam, the frame plates positioned within the box cover with the exterior sides of the top and bottom frame plates adjacent the inner sides of the top and bottom walls of the box cover respectively, the box cover adapted to longitudinally slide over the frame plates, the wall of the box frame adjacent the frame plate having the two registration holes having at least one protuberance extending toward the frame plate and positioned to engage one registration hole when the box cover is slid to one back set position and to engage the other registration hole when the box cover is slid to the other back set position.

17. The dual backset tubular door lock according to claim 16 wherein one of the frame plates having at least one finger near its posterior end extending to the other frame plate, the other frame plate having at least one finger slot near its posterior end, each finger extending to and through a separate finger slot in the other frame plate, and one of the top or bottom walls of the box cover having at least one elongated slot near its posterior end, each finger extending through a separate elongated slot and adapted to move along the length thereof when the box cover is slid from one backset position to the other backset position, at least one finger engaging one end of an elongated slot when the cover is slid to one backset position and at least one finger engaging the other end of an elongated slot when the box cover is slid to the other backset position.

18. A dual backset tubular door lock comprising a latch-bolt assembly and a connected actuator assembly:
the latch-bolt assembly having a bolt case with an anterior face plate and posterior wall, the posterior wall having a hole, a bolt extendible out of the anterior face plate and retractable into the bolt case, retracting means within the case connected to the bolt, and a bolt extracting plate having an anterior portion and a posterior portion with two longitudinal spaced apart tines, a set of protuberances extending laterally from each tine, the bolt extracting plate extending through the hole in the posterior wall with the anterior portion of the bolt extracting plate within the case and connected to the retracting means and the posterior portion extending out from the posterior wall, the bolt being retracted into the bolt case when the posterior portion of the bolt extracting plate is moved posteriorly away the bolt case and extended out from the case when the posterior portion is moved anteriorly towards the bolt case;
the actuator assembly having an anterior end and posterior end with the anterior end secured to the posterior wall of the bolt case, top and bottom frame plates having anterior ends and posterior ends, a cam, a washer, and a box cover, the frame plates having means for securing their anterior ends to the posterior wall of the bolt case, the frame plates having axially aligned notches and holes to receive mounting posts of a door lock rose, and axially aligned elongated holes having longitudinal axes, the elongated hole of one frame plate being gourd shape with the center portion of the elongated hole between its ends constricted to only receive the first portion of the cylindrical body when the two parallel flats are parallel to the longitudinal axis of the elongated hole to align the cam with its teeth pointing forward, one of the frame plates having at least one finger near its posterior end extending to the other frame plate, the other frame plate having at least one finger slot near its posterior end, each finger extending to and through a separate finger slot in the other frame plate;
the cam having a cylindrical body with first and second portions adapted to be received in the elongated holes of the frame plates and to rotate therein and two teeth with cam surfaces adapted to engage the protuberances on the tines of the bolt extracting plate, the cylindrical body having a hole coaxial with its axis of rotation adapted to received a door lock spindle for rotation of the cam, the first portion of the cylindrical body having two parallel flats, the cam positioned between the frame plates and adapted to be moved longitudinally within the elongated holes;
an arch-shaped washer having an oblong hole adapted to be received by the first portion of the cylindrical body of the cam and to rotate with the cam, the washer mounted on the first portion between the cam teeth and one of the frame plates;
the posterior portion of the bolt extraction plate positioned between one of the frame plates and the cam with the first portion of the cylindrical body positioned between the two tines, the protuberances extending away from the tines towards the other frame plate, each protuberance adapted to be engaged by a cam teeth; and
the box cover having an anterior end and posterior end, parallel side walls, parallel top and bottom walls, and an open anterior end, the top and bottom walls having a posterior and anterior notches to receive mounting posts of a door lock rose, the notches being axially aligned when the box cover is positioned at the either backset position with the notches and holes of the frame plates, the top and bottom walls having axially aligned bushings to receive for rotation the first and second portions of the cylindrical body of the cam, at least one of the top or bottom walls having at least one elongated slot near its posterior end, each finger extending through a separate elongated slot, towards and away from the bolt case, each finger extending through an elongated slot and adapted to move along the length thereof when box cover is slide from one backset position to the other backset position, at least one finger engaging one end of an elongated slot when the cover is slid to one backset position and at least one finger engaging the other end of an elongated slot when the box cover is slid to the other backset position, the frame plates positioned within the box cover with the exterior sides of the top and bottom frame plates adjacent the inner sides of the top and bottom walls of the box cover respectively, the box cover adapted to longitudinally slide over the frame plates.

19. A dual backset tubular door lock comprising a latch-bolt assembly and a connected actuator assembly;
the latch-bolt assembly having a bolt case with an anterior face plate and posterior wall, the posterior wall having a hole, a bolt extendible out of the anterior face plate and retractable into the bolt case, retracting means within the case connected to the bolt, and a bolt extracting plate having an anterior portion and a posterior portion with two longitudinal spaced apart tines, a set of protuberances extending laterally from each tine, the bolt extracting plate extending through the hole in the posterior wall with the anterior portion of the bolt extracting plate within the case and connected to the retracting means and the posterior portion extending out from the posterior wall, the bolt being retracted into the bolt case when the posterior portion of the bolt extracting plate is moved posteriorly away the bolt case and extended out from the case when the posterior portion is moved anteriorly towards the bolt case;
the actuator assembly having an anterior end and posterior end with the anterior end secured to the posterior wall of the bolt case, top and bottom frame plates having anterior ends and posterior ends, a cam, a washer, and a box cover, the frame plates having means for securing their anterior ends to the posterior wall of the bolt case, the frame plates having axially aligned notches and holes to receive mounting posts of a door lock rose, and axially aligned elongated holes having longitudinal axes, the elongated hole of one frame plate being gourd shape with the center portion of the elongated hole between its ends constricted to only receive the first portion of the cylindrical body when the two parallel flats are parallel to the longitudinal axis of the elongated hole to align the cam with its teeth pointing forward, one of the frame plates having at least one finger near its posterior end extending to the other frame plate, the other frame plate having at least one finger slot near its posterior end, each finger extending to and through a separate finger slot in the other frame plate, at least one of the frame plates having at least two registration holes longitudinally spaced apart;
the cam having a cylindrical body with first and second portions adapted to be received in the elongated holes of the frame plates and to rotate therein and two teeth with cam surfaces adapted to engage the protuberances on the tines of the bolt extracting plate, the cylindrical body having a hole coaxial with its axis of rotation adapted to received a door lock spindle for rotation of the cam, the first portion of the cylindrical body having two parallel flats, the cam positioned between the frame plates and adapted to be moved longitudinally within the elongated holes;
an arch-shaped washer having an oblong hole adapted to be received by the first portion of the cylindrical body of the cam and to rotate with the cam, the washer mounted on the first portion between the cam teeth and one of the frame plates;
the posterior portion of the bolt extraction plate positioned between one of the frame plates and the cam with the first portion of the cylindrical body positioned between the two tines, the protuberances extending away from the tines towards the other frame plate, each protuberance adapted to be engaged by a cam teeth; and
the box cover having an anterior end and posterior end, parallel side walls, parallel top and bottom walls, and an open anterior end, the top and bottom walls having a posterior and anterior notches to receive mounting posts of a door lock rose, the notches being axially aligned when the box cover is positioned at the either backset position with the notches and holes of the frame plates, the top and bottom walls having axially aligned bushings to receive for rotation the first and second portions of the cylindrical body of the cam, at least one of the top or bottom walls having at least one elongated slot near its posterior end, each finger extending through a separate elongated slot and adapted to move along the length thereof when box cover is slide from one backset position to the other backset position, at least one finger engaging one end of an elongated slot when the cover is slid to one backset position and at least one finger engaging the other end of an elongated slot when the box cover is slid to the other backset position, the frame plates positioned within the box cover with the exterior sides of the top and bottom frame plates adjacent the inner sides of the top and bottom walls of the box cover respectively, the box cover adapted to longitudinally slide over the frame plates, the wall of the box frame adjacent the frame plate having the two registration holes having at least one protuberance extending toward the frame plate and positioned to engage one registration hole when the box cover is slid to one back set position and to engage the other registration hole when the box cover is slid to the other back set position.
